(19) United States
(12) Patent Application Publication
(10) Pub. No.: US 2025/0231776 A1
(43) Pub. Date: Jul. 17, 2025

(54) DYNAMIC INTERFACE GENERATION USING MICRO-FRONTENDS

(71) Applicant: Lenovo Enterprise Solutions (Singapore) Pte. Ltd., New Tech Park (SG)

(72) Inventors: Alexandru Cozma, Bucharest (RO); Valentin Paun, Ilfov (RO); Ioana Voicu, Bucharest (RO); Andrei Oprin, Targoviste (RO); Andrei Dumitrescu, Bucharest (RO); Marioara-Alina Tucunete, Bucharest (RO); Serban Cochilet, Bucharest (RO); Mihai-Razvan Tudorache, Otopeni (RO)

(21) Appl. No.: 18/413,617

(22) Filed: Jan. 16, 2024

(51) Int. Cl. G06F 9/451; G06F 40/106

(52) U.S. Cl. CPC G06F 9/451; G06F 40/106

(57) ABSTRACT

A method for webpage generation is disclosed. The method includes receiving configuration data from each of a plurality of micro-frontends registered with a backend orchestrator service, each of the plurality of micro-frontends is configured to provide content to be displayed on a graphical user interface (“GUI”). Each micro-frontend is configured to provide content of at least one content type. Each of the plurality of micro-frontends is from a content provider. The method includes reading the configuration data from each of the plurality of micro-frontends. The configuration data of a micro-frontend of the plurality of micro-frontends includes identification of the micro-frontend and size and position information for display on the GUI of the content of the micro-frontend. The method includes generating a UI definition file. The UI definition file includes the configuration data from the plurality of micro-frontends. The method includes publishing the GUI from the UI definition file.

### FIELD

The subject matter disclosed herein relates to graphical user interfaces with micro-frontends and more particularly relates to dynamic interface generation using micro-frontends.

### BACKGROUND

User interfaces (“UIs”) serve as points of interaction with a user that allow a user to receive and/or input information. UIs include components, such as visual elements, interactive features, and/or navigation elements. UIs are typically created by manually writing code in a file, which can be time consuming.

### BRIEF SUMMARY

A method for UI generation is disclosed. An apparatus and computer program product also perform the functions of the method. The method includes receiving configuration data from each of a plurality of micro-frontends registered with a backend orchestrator service. Each of the plurality of micro-frontends is configured to provide content to be displayed on a graphical user interface (“GUI”). Each of the plurality of micro-frontends is from a content provider that provides the content for the micro-frontend. The method includes reading the configuration data from each of the plurality of micro-frontends. The configuration data of a micro-frontend of the plurality of micro-frontends includes identification of the micro-frontend and size and position information for display on the GUI of the content of the micro-frontend. The method includes generating a UI definition file. The UI definition file includes the configuration data from the plurality of micro-frontends. The method includes publishing the GUI from the UI definition file.

An apparatus for UI generation includes a micro-frontend ID module configured to receive configuration data from a plurality of micro-frontends registered with a backend orchestrator service, each of the plurality of micro-frontends is configured to provide content to be displayed on a GUI. Each of the plurality of micro-frontends is from a content provider that provides the content for the micro-frontend. The apparatus includes a configuration module configured to read the configuration data from each of the plurality of micro-frontends. The configuration data of a micro-frontend of the plurality of micro-frontends includes identification of the micro-frontend and size and position information for display on the GUI of the content of the micro-frontend. The apparatus includes a generation module configured to generate a UI definition file. The UI definition file includes the configuration data from the plurality of micro-frontends. The apparatus includes a publishing module configured to publish the GUI from the UI definition file. At least a portion of the modules include hardware circuits, a programmable hardware device and/or code. The code is stored on non-transitory computer readable storage media.

A computer program product for UI generation includes a non-transitory computer readable storage medium storing code. The code is configured to be executable by a processor to perform operations. The operations include receiving configuration data from each of a plurality of micro-frontends registered with a backend orchestrator service, each of the plurality of micro-frontends is configured to provide content to be displayed on a graphical user interface (“GUI”). Each of the plurality of micro-frontends is from a content provider that provides the content for the micro-frontend. The operations include reading the configuration data from each of the plurality of micro-frontends. The configuration data of a micro-frontend of the plurality of micro-frontends include identification of the micro-frontend and size and position information for display on the GUI of the content of the micro-frontend. The operations include generating a UI definition file that includes the configuration data from the plurality of micro-frontends. The operations include publishing the GUI from the UI definition file.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system, according to various embodiments;

FIG. 2 is a schematic block diagram illustrating a shell apparatus, according to various embodiments;

FIG. 3 is a schematic block diagram illustrating another shell apparatus, according to various embodiments;

FIG. 4A is a schematic block diagram illustrating a graphical user interface (“GUI”), according to various embodiments;

FIG. 4B is a schematic block diagram illustrating an updated GUI, according to various embodiments;

FIG. 5 is a schematic block diagram illustrating a GUI having one or more fixed elements, according to various embodiments;

FIG. 6 is a schematic flow chart diagram illustrating a method for generating a GUI, according to various embodiments;

FIG. 7A is a schematic flow chart diagram illustrating steps of another method for generating a GUI, according to various embodiments;

FIG. 7B is a schematic flow chart diagram illustrating further steps of the method of FIG. 7A, according to various embodiments;

FIG. 8A is a schematic flow chart diagram illustrating steps of a method for publishing and updating a GUI, according to various embodiments; and

FIG. 8B is a schematic flow chart diagram illustrating further steps of the method of FIG. 8A, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for UI generation is disclosed. An apparatus and computer program product also perform the functions of the method. The method includes receiving configuration data from each of a plurality of micro-frontends registered with a backend orchestrator service. Each of the plurality of micro-frontends is configured to provide content to be displayed on a graphical user interface (“GUI”). Each of the plurality of micro-frontends is from a content provider that provides the content for the micro-frontend. The method includes reading the configuration data from each of the plurality of micro-frontends. The configuration data of a micro-frontend of the plurality of micro-frontends includes identification of the micro-frontend and size and position information for display on the GUI of the content of the micro-frontend. The method includes generating a UI definition file. The UI definition file includes the configuration data from the plurality of micro-frontends. The method includes publishing the GUI from the UI definition file.

In some examples, the method includes defining, based at least in part on the configuration data, a number of rules for a layout for the GUI. The number of rules are configured to resolve a layout conflict between the configuration data of the plurality of micro-frontends. The UI definition file includes the number of rules. In some examples, the layout conflict includes an overlap between a first area of the GUI and a second area of the GUI. The first area of the GUI is defined by configuration data of a first micro-frontend of the plurality of micro-frontends. The second area of the GUI is defined by configuration data of a second micro-frontend of the plurality of micro-frontends. In some examples, defining, based at least in part on the configuration data, the number of rules includes identifying a conflict between configuration data of a first micro-frontend of the plurality of micro-frontends and configuration data of a second micro-frontend of the plurality of micro-frontends and determining a priority between the first micro-frontend and the second micro-frontend.

In some examples, reading the configuration data from each of the plurality of micro-frontends includes reading the configuration data from a backend orchestration service. Each of the plurality of micro-frontends registers with the backend orchestration service and transmits configuration data of the micro-frontend to the backend orchestration service. In some examples, the backend orchestration service is configured to combine the configuration data of each of the plurality of micro-frontends into a unified structure configured to be used to generate the user interface definition file. In some examples, publishing the GUI further includes accessing, via the backend orchestration service, the content from each of the plurality of micro-frontends.

In some examples, the method includes selecting a number of fixed elements not provided by the content provider, and publishing the GUI includes publishing each of the number of fixed elements to the GUI. In some examples, the number of fixed elements includes at least one of: a header of a page of the GUI, a footer of a page of the GUI, a navigation element of the GUI, a web address bar, a menu of the GUI, and/or any combination thereof.

In some examples, each of the plurality of micro-frontends includes an address associated with the GUI. In some examples, the size and position information include at least one of: a total area of the micro-frontend on the GUI, a page of the GUI on which to position the micro-frontend, and/or a region of a page of the GUI on which to position the micro-frontend.

In some examples, the method includes determining that an additional micro-frontend has registered with the backend orchestration service, content is available for a registered micro-frontend that was previously unavailable, and/or a micro-frontend of the plurality of micro-frontends is unavailable. In the examples, the method includes reading configuration data from the additional micro-frontend and/or removing configuration data from the deselected micro-frontend and the method includes updating the UI definition file based at least in part on the additional configuration data and/or the removed configuration data and re-publishing, using the updated user interface UI definition file, the GUI.

An apparatus for UI generation includes a micro-frontend ID module configured to receive configuration data from a plurality of micro-frontends registered with a backend orchestrator service, each of the plurality of micro-frontends is configured to provide content to be displayed on a GUI. Each of the plurality of micro-frontends is from a content provider that provides the content for the micro-frontend. The apparatus includes a configuration module configured to read the configuration data from each of the plurality of micro-frontends. The configuration data of a micro-frontend of the plurality of micro-frontends includes identification of the micro-frontend and size and position information for display on the GUI of the content of the micro-frontend. The apparatus includes a generation module configured to generate a UI definition file. The UI definition file includes the configuration data from the plurality of micro-frontends. The apparatus includes a publishing module configured to publish the GUI from the UI definition file. At least a portion of the modules include hardware circuits, a programmable hardware device and/or code. The code is stored on non-transitory computer readable storage media.

In some examples, the apparatus includes a rules module configured to define, based at least in part on the configuration data, a number of rules for a layout for the GUI. The number of rules are configured to resolve a layout conflict between the configuration data of the plurality of micro-frontends. The UI definition file further includes the number of rules. In some examples, the layout conflict includes an overlap between a first area of the GUI and a second area of the GUI. The first area of the GUI is defined by configuration data of a first micro-frontend of the plurality of micro-frontends, and the second area of the GUI is defined by configuration data of a second micro-frontend of the plurality of micro-frontends. In some examples, the apparatus includes a conflict module configured to identify a conflict between configuration data of a first micro-frontend of the plurality of micro-frontends and configuration data of a second micro-frontend of the plurality of micro-frontends. In some examples, the apparatus includes a priority module configured to determine a priority between the first micro-frontend and the second micro-frontend.

In some examples, the apparatus includes a backend module configured to read the configuration data from a backend orchestration service. In some examples, each of the plurality of micro-frontends registers with the backend orchestration service and transmits configuration data of the micro-frontend to the backend orchestration service. In some examples, the apparatus includes a structure module configured to combine the configuration data of each of the plurality of micro-frontends into a unified structure, the unified structure configured to be used by the generation module to generate the user interface definition file. In some examples, the publishing module is further configured to publish the GUI by accessing, via the backend orchestration service, the content from each of the plurality of micro-frontends.

A computer program product for UI generation includes a non-transitory computer readable storage medium storing code. The code is configured to be executable by a processor to perform operations. The operations include receiving configuration data from each of a plurality of micro-frontends registered with a backend orchestrator service, each of the plurality of micro-frontends is configured to provide content to be displayed on a GUI. Each of the plurality of micro-frontends is from a content provider that provides the content for the micro-frontend. The operations include reading the configuration data from each of the plurality of micro-frontends. The configuration data of a micro-frontend of the plurality of micro-frontends include identification of the micro-frontend and size and position information for display on the GUI of the content of the micro-frontend. The operations include generating a UI definition file that includes the configuration data from the plurality of micro-frontends. The operations include publishing the GUI from the UI definition file.

UIs, such as GUIs, serve as points of interaction with a user that allow a user to receive and/or input information. UIs include components, such as dynamic elements and/or fixed elements. Micro-frontends are dynamic, independent, self-contained UI elements that can be developed, deployed, and scaled independently. Using micro-frontends with GUIs, in some embodiments, allows multiple different content providers to contribute to a GUI independently and efficiently. As such, micro-frontends, in some instances, help to increase modularity, agility, efficiency, and case of customization for GUIs. Granting content providers of each micro-frontend the ability to influence how micro-frontends appear on a GUI, in some cases, helps to improve interface functionality and allow the interface to be generated and/or updated more efficiently. As such, examples of the present disclosure include methods, apparatus, and computer program products for improving generation and updating of GUIs and for determining GUI layout based at least in part on input from micro-frontends.

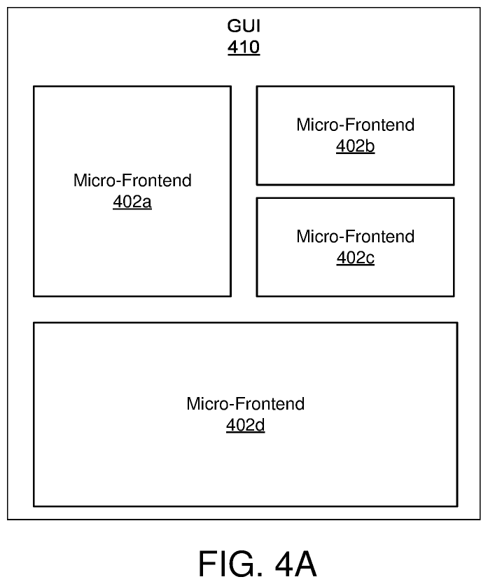

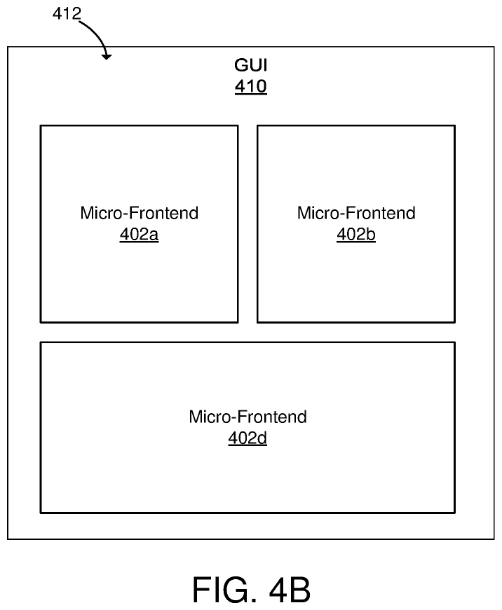

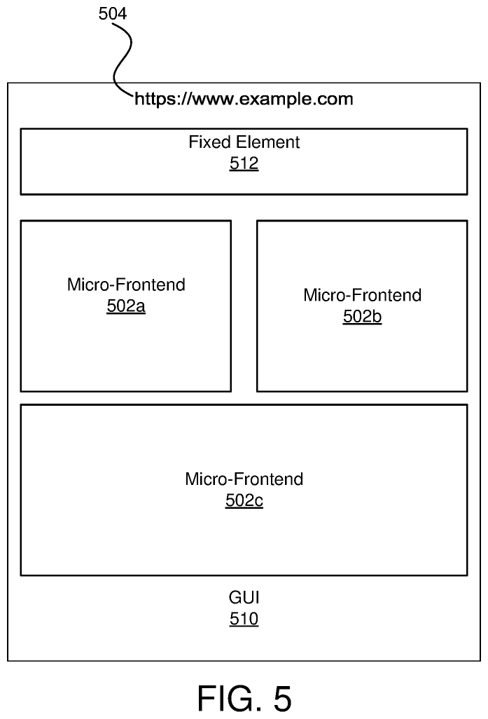

As used herein, the term “micro-frontend” refers to an individual, self-contained component of a software architecture that is configured to provide content for a UI independently of other components of the architecture. In some examples, the architecture also includes a shell UI, which is an underlying framework and container for the UI. As used herein, the micro-frontends of an architecture provide self-contained blocks of content for the UI, and the shell UI provides at least one of a background and/or a fixed clement for the pages of the UI on which the micro-frontends appear. Although the blocks of content shown in FIGS. 4A, 4B and 5 are referred to as “micro-frontends,” those of skill in the art will appreciate that the term “micro-frontend” refers not only to the resulting elements shown on a UI but also to the self-contained components of the software architecture for that UI.

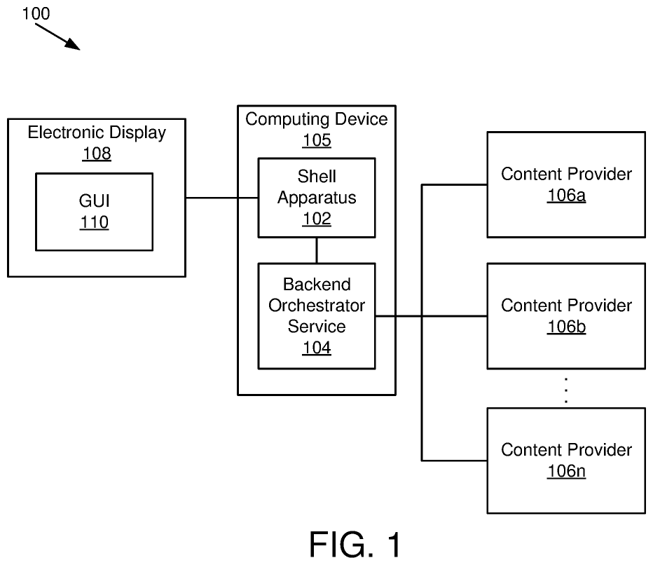

FIG. 1 is a schematic block diagram illustrating a system 100, according to various embodiments. The system 100 includes a number of content providers 106a-n (referred to herein, generically, and/or collectively, as “106”), a shell apparatus 102 and a backend orchestration service 104 in a computing device 105, a backend orchestration service 104, an electronic display 108, and a GUI 110.

In some examples, each of the number of content providers 106 is configured to independently provide content for the GUI 110 through a micro-frontend (e.g., micro-frontends 402a-d, shown in FIG. 4A). In some examples, the content providers 106 communicate with the shell apparatus 102 via a backend orchestration service 104, which functions as a reverse proxy between the shell apparatus 102 and the content providers 106. In some examples, the computing device 105 includes a server of an orchestrator service and/or orchestration system. In some examples, the computing device 105 includes a server of an open-source container orchestration system.

In some examples, the computing device 105 may be a rack-mounted server, a blade server, a desktop computer, a mainframe computer, a laptop computer, a tablet, a mobile device, or the like and may include two or more computing devices operating together. In some examples, the computing device 105 includes storage, a power supply, one or more processors, memory, and/or other typical components of a computing device. In some examples, the computing device 105 is configured to perform one or more functions described herein in association with the shell apparatus 102, such as: reading configuration data from one or more micro-frontends, defining a layout of the GUI 110 based at least in part on the configuration data, defining one or more rules for the layout, and/or any combination thereof. In some examples, the shell apparatus 102 is in another computing device and the computing device 105 is configured to serve as an intermediary between the computing device with the shell apparatus 102 and the content providers 106 by communicating with the micro-frontends to obtain assets for generation of the GUI 110, such as HyperText Markup Language (“HTML”), Cascading Style Sheets (“CSS”), JavaScript (“JSS”), and/or language files.

In some examples, the shell apparatus 102 is configured to generate a UI definition file used to generate the GUI 110 for display on the electronic display 108. The GUI 110 includes each of the micro-frontends, as shown in FIGS. 4A, 4B, and 5. In some examples, the shell apparatus 102 receives and/or reads configuration data from each of the content providers 106 via micro-frontends, and the configuration data dictates a layout of the GUI 110. In some examples, the shell apparatus 102 generates a UI definition file that includes the configuration data of the micro-frontends. In some examples, the shell apparatus 102 publishes the GUI 110 on the electronic display 108 using the UI definition file. In some examples, the shell apparatus 102 creates pages of a GUI 110 dynamically based at least in part on the configuration data. In some examples, the shell apparatus 102 includes a shell UI and/or a shell project.

In some examples, each of the micro-frontends 402 is served by a different web server that communicates with the backend orchestration service 104. In some examples, each of the micro-frontends includes its own container, and each micro-frontend is packaged and deployed as an independent unit, isolated from other micro-frontends and from the shell apparatus 102. In some examples, a container includes a package of software that includes all of the components and code needed for a micro-frontend to run on an application. In some embodiments, each of the micro-frontends 402 includes address information associated with the GUI 110 so that content from each micro-frontend is displayed on the GUI 110.

In some examples, each of the content providers 106 includes a computing device, such as a server and/or another hardware component configured to provide content for display on the GUI 110. In some examples, the content providers 106 are configured to compile, analyze, and/or relay data from a number of other devices to the backend orchestration service 104, which pushes such content to the GUI 110. In some examples, each of the content providers 106 is configured to receive data from a number of devices in a data center. In some examples, the content providers 106 are further configured to analyze, manipulate, compile, and/or convert that data into a visual representation, such as a chart, table, graph, and/or other visual representation. In some examples, that visual representation is then included on the GUI 410 via a micro-frontend 402.

In some examples, the content providers 106 are configured to receive input from a user. In some examples, a content provider 106 includes a computing device configured to receive input from a user. In such examples, the user may contribute to, edit, and/or upload elements to a GUI 410 via micro-frontend 402 corresponding to that content provider 106. In some examples, each of the content providers 106 are in different physical locations.

In some examples, the electronic display 108 includes any device or portion of a device configured to present information electronically, such as information presented on the GUI 110. The electronic display 108 includes, for example, a display of a computing device, such as, the computing device 105 and/or another computing device. In some examples, the electronic display 108 includes a light-emitting diode display, an electroluminescent display, a liquid crystal display, or other current technology.

In some examples, the computing device 105, backend orchestration service 104, and/or content providers 106 communicate over one or more computer networks (not shown). The computer networks may include a LAN, a WAN, a fiber optic network, a public network, such as the Internet, or other appropriate network. In some embodiments, the computer networks includes a wireless connection. In some embodiments, the computer networks include two or more networks. In various embodiments, the electronic display 108 is connected to the computing device 105 over a wired or a wireless connection and may include a computer network.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM” ®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

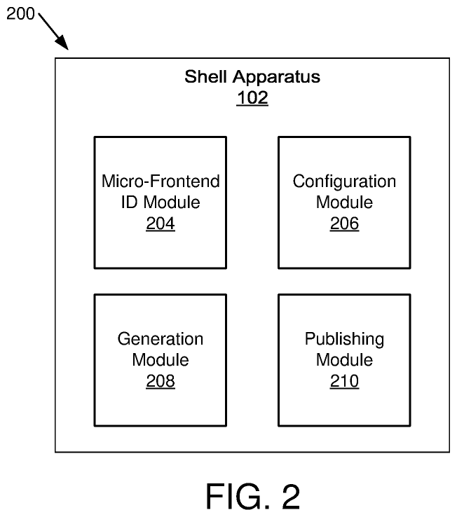

FIG. 2 is a schematic block diagram illustrating an apparatus 200 for generating a GUI, according to various embodiments. The apparatus 200 includes a shell apparatus 102, as shown in FIG. 1. The apparatus 200 includes a micro-frontend ID module 204, a configuration module 206, a generation module 208, and/or a publishing module 210. In some embodiments, all or a portion of the apparatus 200 is implemented with executable code stored on computer readable storage media. In other embodiments, at least a portion of the apparatus 200 is implemented using hardware circuits and/or a programmable hardware device.

The apparatus 200 includes a micro-frontend ID module 204, which is configured to receive configuration data from a plurality of micro-frontends registered with a backend orchestrator service 104. Each of the plurality of micro-frontends is configured to provide content to be displayed on a GUI 110. In some examples, the GUI 410 and/or the GUI 510 are embodiments of the GUI 110. In some embodiments, the micro-frontend ID module 204 is configured to receive configuration data from all micro-frontends that register with the backend orchestration service 104. In some examples, the shell apparatus 102 is configured to automatically include whichever micro-frontends register with the backend orchestration service 104 in the GUI 110.

In some examples, a designer selects a plurality of content types to include in the GUI 110 and may select micro-frontends of a particular theme, of different types, etc. In some examples, the designer selects content types such that the GUI 110 includes a variety of subject matter. In some examples, each of the content types is of a category of a multitude of categories of subject matter. Categories of subject matter include, for example, but are not limited to product data, billing data, financial data, user data, employee data, resource utilization data, news, system notifications, company and/or brand identifiers, other data that is relevant for an application on which the GUI 110 is provided, and/or any combination thereof. The designer then creates or selects micro-frontends to be included on the GUI 110 and codes an address into the micro-frontend corresponding to the GUI 110 so that content from the micro-frontend will be displayed on the GUI 110. The designer may then enable the micro-frontends to register with the background orchestrator service 104. In some examples, the shell apparatus 102 is configured to receive a selection of content types from the designer merely by the micro-frontend ID module 204 receiving the registered micro-frontends.

In some embodiments, the content types include various reporting metrics based on data received from computing devices of a datacenter. In some embodiments, the data received from the datacenter is received over a management network (not shown) and the content types are selected by a designer to provide information to a customer leasing computing devices used in the datacenter. In the embodiments, the designer creates micro-frontends that access the data from the datacenter and have an address that correlates with the GUI 110 so that the data from the datacenter is presented on the GUI 110. In some embodiments, the address associated with the GUI 110 is an internet protocol (“IP”) address. For example, the address may be of the form https://application-demo/billing. In other embodiments, the address is a subnet address or an address of some other form that is interpreted by a network to point to the GUI 110. One of skill in the art will recognize addresses that are recognizable by a network so that the micro-frontend with the address is included in a particular GUI 110.

In some examples, each micro-frontend of the plurality of micro-frontends is configured to provide content of at least one content type determined by the designer. In some examples, each of the plurality of micro-frontends is from a content provider 106 that provides the content for the micro-frontend. For example, referring to FIG. 4A, a first micro-frontend 402a is configured to provide content of a first content type, the content supplied by a first content provider 106a. In some examples, a second micro-frontend 402b is configured to provide content of a second content type different from the first content type, the content supplied by a second content provider 106b different from the first content provider 106a.

In some examples, the configuration module 206 is configured to read and/or receive the configuration data from each of the plurality of micro-frontends. In some examples, reading the configuration data from each micro-frontend includes reading the configuration data from the backend orchestration service 104. In such examples, each of the micro-frontends registers with the backend orchestration service 104 and transmits the configuration data to the backend orchestration service 104. In some examples, each of the micro-frontends transmit configuration data to the shell apparatus 102 through the backend orchestration service 104 during and/or after registering with the shell apparatus 102 via the backend orchestration service 104.

In some examples, the configuration data includes details regarding how the micro-frontend should be displayed on the GUI 110. In some examples, the configuration data of a micro-frontend of the plurality of micro-frontends includes at least one of the following for displaying the content of the micro-frontend on the GUI: identification of the micro-frontend, size, and/or position on the GUI 110.

In some examples, the configuration data includes an identification of the micro-frontend. In some examples, the identification of the micro-frontend includes an identification of the content provider 106. In some examples, the identification of the micro-frontend includes an internal identifier of the micro-frontend to help the shell apparatus 102 identify the micro-frontend, such as a number and/or a string of characters.

In some examples, the configuration data includes a size and/or position information for the micro-frontend. In some examples, the size and position information includes a total area of the micro-frontend 402 on the GUI 410, a page 412 of the GUI 410 on which to position the micro-frontend 402, and/or a region of a page 412 of the GUI 410 on which to position the micro-frontend 402. In some examples, the size and/or position information includes a size in pixels of the total area of the micro-frontend 402 to be displayed on the GUI 410. In some examples, the size and/or position information indicates the total area of the micro-frontend 402 relative to a total area of a page of the GUI 410 on which the micro-frontend 402 is found. For example, the micro-frontend 402a's configuration data indicates that the micro-frontend 402a should occupy approximately one-fifth of the total area of the page 412 of the GUI 410 on which the micro-frontend 402a is positioned.

In some examples, the GUI 410 includes multiple pages 412, and the configuration data includes a page order identifying which page 412 the micro-frontend 402 should be displayed on. For example, the configuration data of the micro-frontend 402a indicates that the micro-frontend 402a should be displayed on a first page 412 of the GUI 410.

In some examples, a region of a page 412 of the GUI 410 on which to position the micro-frontend includes, for example: top half, bottom half, right half, left half, center, header, footer, margin, and/or any combination thereof. For example, the configuration data of the micro-frontend 402a indicates that the micro-frontend 402a should be displayed on the top half of the page 412 and/or on the left half of the page 412, from a user's perspective when viewing the electronic display 108. In some examples, the size and position information includes a position on the page 412 relative to other micro-frontends 402, which includes: first, last, middle, and/or any combination thereof. In some examples, the configuration data of a micro-frontend 402d indicates that the micro-frontend 402d should be displayed below other micro-frontends 402a-c on the page 412.

In some examples, the generation module 208 is configured to generate a UI definition file. In some examples, the UI definition file includes a file that defines the GUI 110, the layout of the GUI 110, and/or other aspects of the GUI 110. In some examples, the UI definition file is an XML file. In some examples, the UI definition file includes the configuration data and identifiers for each of the plurality of micro-frontends. In some examples, the UI definition file includes: the configuration data, a layout generated based at least in part on the configuration data, an indication of each micro-frontend to be displayed on the GUI 110, and/or any combination thereof. In some examples, the backend orchestration service 104 is configured to combine the configuration data of each of the plurality of micro-frontends into a unified structure configured to be used to generate the user interface definition file.

In some examples, the generation module 208 is configured to generate the UI definition file without receiving any input regarding and/or determining a structure or layout of the GUI 110 before the configuration module 206 reads the configuration data. In some examples, the generation module 208 is configured to generate the UI definition file without knowledge of and/or input regarding the content of the micro-frontends. In some examples, the generation module 208 generates a layout for the GUI 110 based on the configuration data. In some examples, the generation module 208 includes a set of rules for generating the layout in combination with the configuration data to provide a position, page, and/or total area for a micro-frontend 402 if such information is not included in the configuration data. In some examples, the generation module 208 is configured to generate a UI definition file that positions a micro-frontend 402 on a first page 412 of the GUI 410 if the configuration data does not include a page order for the micro-frontend 402 and there is sufficient space for the micro-frontend 402 on the first page 412.

In some examples, the generation module 208 is configured to generate the UI definition file in real-time as micro-frontends register with a backend orchestration service 104. In some examples, the shell apparatus 102 is not aware of size and position data of micro-frontends 402 prior to reading configuration data from the micro-frontends 402. In such examples, the shell apparatus 102 generates the layout for the GUI 110 only after receiving the configuration data. In some examples, prior to registration of the micro-frontends, the GUI 410 does not include any micro-frontends, and the shell apparatus 102 does not have a pre-defined layout for the GUI 410.

In some examples, the generation module 208 is configured to determine, based at least in part on the configuration data and on a quantity of registered micro-frontends 402, a quantity of pages 412 of the GUI 410. In some examples, the quantity of pages 412 is less than a quantity of the micro-frontends 402, such that at least one page 412 includes more than one micro-frontend 402. In some examples, the generation module 208 is configured to determine the quantity of pages 412 based at least in part on the size and position data of the micro-frontends 402 and a quantity of micro-frontends that can fit on a page 412 of the GUI 410 given that size and position data.

In some embodiments, the GUI 410 includes two pages, such as a products page and a billing page and the generation module 208 generates a UI definition file for each page. The products page may display content from N micro-frontends and the billing page may display content from M micro-frontends so that N+M micro-frontends register with the backend orchestrator service 104. Each of the N micro-frontends may include an address of https://application-demo/products and each of the M micro-frontends may include an address of https://application-demo/billing. In the embodiments, the generation module 208 and/or the publishing module 210 displays the product page and the billing page as two pages of a GUI 410.

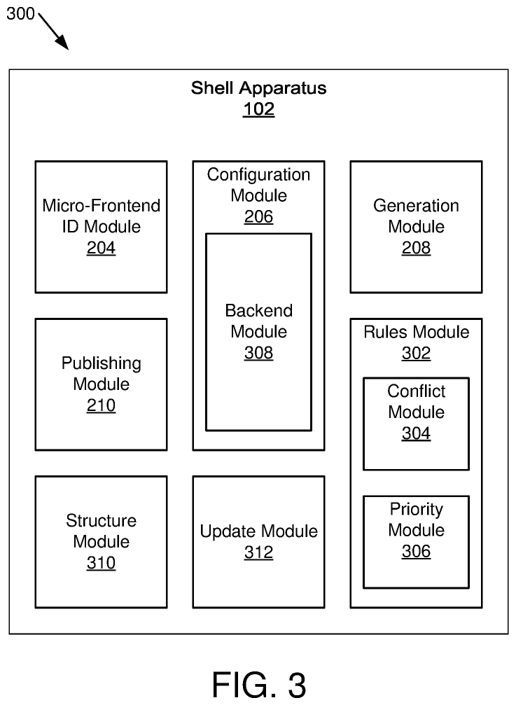

Although FIGS. 2 and 3 show the configuration module 206 and generation module 208 as part of the shell apparatus 102, examples of the present disclosure are not so limited. In some examples, functions described herein in connection with the configuration module 206 and/or the generation module 208 are performed by the backend orchestration service 104. In some examples, the backend orchestration service 104 is configured to generate a unified structure for the GUI 110 and transmit that structure to the shell apparatus 102. In some examples, the generation module 208 is configured to generate the UI definition file based at least in part on the output of the backend orchestration service 104 and/or on a number of fixed elements defined, received, and/or selected by the shell apparatus 102. In some examples, the generation module 208 is configured to generate a UI file in response to receiving the structure from the backend orchestration service 104.

In some examples, the publishing module 210 is configured to publish the GUI 110 to an electronic display 108. In some examples, the publishing module 210 publishes the GUI 110 using the UI definition file. In some examples, the publishing module 210 is configured to publish the GUI 110 by accessing, via the backend orchestration service 104, content from each of the plurality of micro-frontends. In some examples, the backend orchestration service 104 acts as a reverse proxy and/or an intermediary between the computing device 105 and the content providers 106 that communicates with the content providers 106 to obtain files and/or content, such as HTML, CSS, and/or JSS files. In some examples, publishing the GUI 110 includes adding micro-frontends 402 to a GUI 410 that previously did not include any dynamic components.

In some examples, the published GUI 410 includes micro-frontends 402 that include at least one of: a card, a widget, a graphic, a table, and/or any combination thereof. In some examples, the micro-frontends 402 are interactive components that are configured to receive user input. In some examples, the micro-frontends 402 can be updated without re-publishing the GUI 410.

FIG. 3 is a schematic block diagram illustrating an apparatus 300 for generating a GUI, according to various embodiments. The apparatus 300 includes a shell apparatus 102, as shown in FIGS. 1-2. The apparatus 300 includes a micro-frontend ID module 204, a configuration module 206, a generation module 208, and/or a publishing module 210, which are substantially similar to those described above with regards to the apparatus 200 of FIG. 2. In various embodiments, the apparatus 300 includes a rules module 302, a conflict module 304, a priority module 306, a backend module 308, a structure module 310, and/or an update module 312, which are described below. In some embodiments, the apparatus 300 is implemented in a similar way as the apparatus 200 of FIG. 2.

In some examples, the rules module 302 is configured to define, based at least in part on the configuration data, a number of rules for a layout for the GUI 110. In some examples, the layout includes the size and position of each micro-frontend 402 on the GUI 410. In some examples, the shell apparatus 102 defines the number of rules without input from the micro-frontends 402 and/or before the micro-frontends register. In some examples, the generation module 208 is configured to generate the UI definition file based at least in part on the number of rules.

In some examples, the rules module 302 includes a conflict module 304 configured to resolve a layout conflict between the configuration data of the micro-frontends 402. In some examples, the layout conflict includes an overlap between a first area of the GUI 410 and a second area of the GUI 410. In some examples, the first area of the GUI 410 is an area defined by configuration data of a first micro-frontend. For example, the area defined by the configuration data of the first micro-frontend 402a is the total area of the GUI 410 which the first micro-frontend 402a occupies after being published. In some examples, the second area of the GUI 410 is defined by configuration data of a second micro-frontend 402b. In FIGS. 4A-B, the first area and the second area do not overlap. However, in some examples, the rules module 302 is configured to define rules for creating a layout of the GUI 410 in cases in which the configuration data of the micro-frontends 402 would cause them to occupy the same and/or overlapping areas of the GUI 410.

In some examples, the conflict module 304 is configured to identify a conflict between configuration data of two micro-frontends 402a, 402b. In some examples, the rules module 302 is configured to define the rules based at least in part on the identified conflict and by determining a priority between the first micro-frontend 402a and the second micro-frontend 402b. In some examples, the rules module 302 includes a priority module 306 configured to determine the priority. In some examples, the priority module 306 is configured to determine the priority based at least in part on a time of registration, a content type, a data type, a priority of a content provider 106, etc. and/or any combination thereof.

In some examples, the configuration module 206 includes a backend module 308 configured to receive configuration data from the backend orchestration service 104. Although not shown in FIG. 3, in some examples, the generation module 208 also includes a generation backend module configured to receive a layout for the GUI 110 from the backend orchestration service 104.

In some examples, the structure module 310 is configured to combine the configuration data of each of the plurality of micro-frontends into a unified structure. In some examples, the generation module 208 uses the unified structure from the structure module 310 to generate the UI definition file. In some examples, the unified structure accommodates each of the micro-frontends 402. Although FIG. 3 shows the structure module 310 as being part of the shell apparatus 102, examples of the present disclosure are not so limited. In some examples, the functions described herein in connection with the structure module 310 are performed by the backend orchestration service 104.

In some examples, the update module 312 is configured to dynamically update the GUI 410 after the publishing module 210 has published the GUI 410. In some examples, the update module 312 is configured to update the GUI 410 in real-time based at least in part on communication from the micro-frontends. In some examples, the micro-frontend ID module 204 is configured to receive configuration data from an additional micro-frontend or a micro-frontend that becomes available that was previously unavailable. In other embodiments, the micro-frontend ID module 204 may not be able to read configuration data from a micro-frontend that was previously available. Additionally and/or alternatively, the configuration module 206 is configured to read data from the additional/available micro-frontend or to determine that configuration data is not available to be read from the micro-frontend and the update module 312 adds the configuration data to the UI definition file from the additional/available micro-frontend. In some examples, the configuration module 206 is configured to receive communication from the micro-frontend (e.g., via the backend orchestration service 104) indicating that the micro-frontend is deregistering from an application of the GUI 410 or that content from a micro-frontend is not available. In some examples, the update module 312 is configured to generate an updated UI definition file, which includes a new UI definition file and/or the original UI definition file with the configuration data of the removed and/or unavailable micro-frontend 402 removed from the UI definition file. In some examples, the publishing module 210 is configured to re-publish, based on input from the update module 312 and using an updated UI definition file, the GUI 410.

For example, FIG. 4A is a schematic block diagram illustrating a GUI 410, according to various embodiments. As shown in FIG. 4A, in some examples, the GUI 410 is initially generated by the shell apparatus 102 to include micro-frontends 402a-d (referred to herein, individually, generically, and/or collectively, as “402”). In some examples, each of the micro-frontends 202 corresponds to a content provider 106. In some examples, the micro-frontend 202a includes content received by the shell apparatus 102 from a first content provider 106a (e.g., via the backend orchestration service 104), and another micro-frontend 202b includes content received by the shell apparatus 102 from a second content provider 106b, and so forth.

In some examples, the shell apparatus 102 receives instructions from the backend orchestration service 104 to remove the micro-frontend 402c from the GUI 410 as described above. FIG. 4B is a schematic block diagram illustrating an updated GUI 410, according to various embodiments. In some examples, the shell apparatus 102 updates the GUI 410 based at least in part on input from a content provider 106. As shown in FIG. 4B, in some examples, updating the GUI 410 includes removing a micro-frontend 402c and re-arranging the remaining micro-frontends 402a, 402b, and 402d in response to the removal. In some examples, re-arranging the micro-frontends 402a, 402b, and 402d includes moving and/or re-sizing a remaining micro-frontend 402b to cover at least part of an area previously covered by the removed micro-frontend 402c. In some examples, the update module 312 is configured to update the GUI 410 to be consistent with any size and/or position parameters set by the configuration data of the remaining micro-frontends 402a, 402b, and 402d.

In some examples, the content providers 106 make changes to the content and/or elements presented within the micro-frontends 402 without communicating directly with the update module 312. In some examples, the content providers 106 make changes to the micro-frontends via, for example, an application programming interface (“API”) and the update module 312 updates the UI definition file as necessary.

In some examples, the GUI 410 is provided via a web and/or mobile application having a refresh button. In some examples, the publishing module 210 and/or the update module 312 are configured to publish an updated GUI 410 in response to the page being refreshed. In some examples, the configuration module 206 is configured to re-read data from the micro-frontends in response to the page being refreshed. In some examples, the generation module 208 is configured to generate a new UI definition file and/or update the UI definition file in response to the re-reading. In some examples, the publishing module 210 is configured to publish updates to the GUI 410 in response to the generating. In some examples, generating a new UI definition file and/or updating the UI definition file includes making changes to the layout of the GUI 410, such as the change shown in FIG. 4B.

FIG. 5 is a schematic block diagram illustrating a GUI 510 having one or more fixed elements, according to various embodiments. In some examples, the user interface definition file also includes a number of fixed elements that are not provided by any of the content providers 106. In some examples, fixed elements include components of the GUI 510 that are not affected and/or updatable by any of the content providers 106 and/or are not micro-frontends. In some examples, the fixed elements are published to the GUI 510 with the micro-frontends. In some examples, the fixed elements include at least one of: a header of a page of the GUI 510, a footer of the page of the GUI 510, a navigation clement of the GUI 510, a web address bar, a menu of the GUI 510, and/or any combination thereof. For example, FIG. 5 illustrates a GUI 510 having a fixed heading 512, a web address navigation bar 504, and a number of micro-frontends 502.

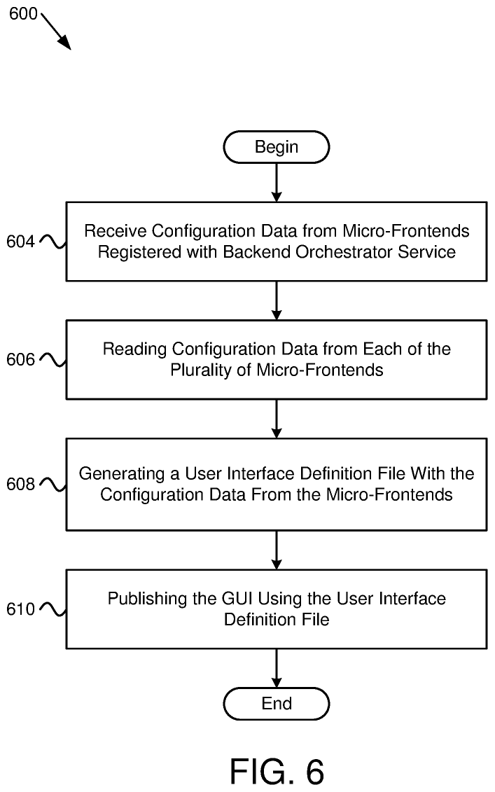

FIG. 6 is a schematic flow chart diagram illustrating a method 600 for generating a GUI 110, according to various embodiments. The method 600 begins and receives 604 configuration data from each of a plurality of micro-frontends registered with a backend orchestrator service 104. In some examples, each of the plurality of micro-frontends is configured to provide content to be displayed on a GUI 110. In some examples, each of the plurality of micro-frontends is from a content provider 106 that provides the content for the micro-frontend. The method 600 includes reading 606 the configuration data from each of the plurality of micro-frontends. In some examples, the configuration data of a micro-frontend of the plurality of micro-frontends includes identification of the micro-frontend and size and position information for display on the GUI 110 of the content of the micro-frontend. In some examples, the method 600 includes generating 608 a UI definition file. In some examples, the UI definition file includes the configuration data from the plurality of micro-frontends. In some examples, the method 600 includes publishing 610, using the UI definition file, the GUI 110. In various examples, all or a portion of the method 600 is implemented using the micro-frontend ID module 204, configuration module 206, generation module 208, and/or publishing module 210 shown in FIGS. 2 and 3.

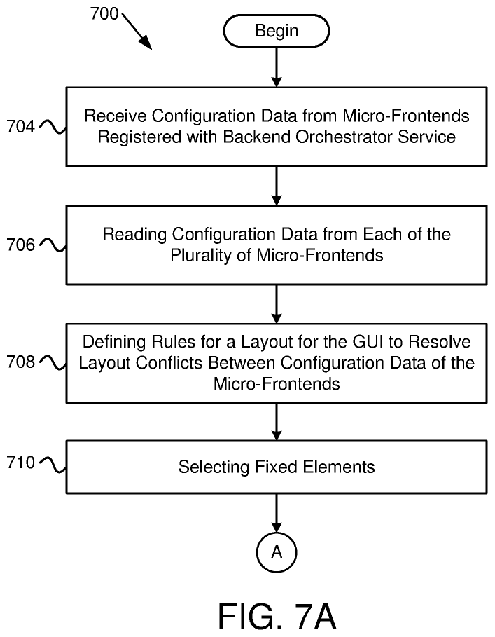

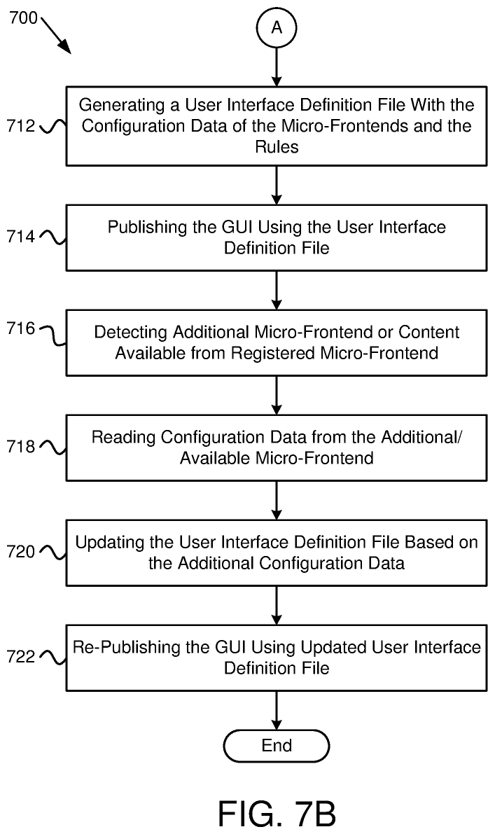

FIG. 7A is a schematic flow chart diagram illustrating steps of another method 700 for generating a GUI 110, according to various embodiments. In some examples, the method 700 begins and receives 704 configuration data from each of a plurality of micro-frontends registered with a backend orchestrator service 104. In some examples, each of the plurality of micro-frontends is configured to provide content to be displayed on a GUI 110. In some examples, each of the plurality of micro-frontends is from a content provider 106 that provides the content for the micro-frontend. The method 700 includes reading 706 the configuration data from each of the plurality of micro-frontends. In some examples, the configuration data of a micro-frontend of the plurality of micro-frontends includes identification of the micro-frontend and size and position information for display on the GUI 110 of the content of the micro-frontend. In some examples, the method 700 includes defining 708, based at least in part on the configuration data, a number of rules for a layout for the GUI 110, the number of rules configured to resolve a layout conflict between the configuration data of the plurality of micro-frontends. In some examples, the UI definition file includes the number of rules. In some examples, the method 700 further includes identifying a conflict between configuration data of a first micro-frontend of the plurality of micro-frontends and configuration data of a second micro-frontend of the plurality of micro-frontends. In some examples, the method 700 includes determining a priority between the first micro-frontend and the second micro-frontend. In some examples, the method 700 includes selecting 710 a number of fixed elements not provided by the content provider.

FIG. 7B is a schematic flow chart diagram illustrating further steps of the method 700 of FIG. 7A, according to various embodiments. In some examples, the method 700 includes generating 712 a UI definition file. In some examples, the UI definition file includes the configuration data and the plurality of micro-frontends. In some examples, the method 710 includes publishing 714, using the UI definition file, the GUI 110. In some examples, publishing 714 the GUI 110 includes publishing each of the number of fixed elements to the GUI 110.

In some examples, the method 700 includes detecting 716 an additional micro-frontend of the plurality of micro-frontends or that content is available from a micro-frontend that was previously unavailable. In some examples, the method 700 includes reading 718 configuration data from the additional/available micro-frontend. In some examples, the method 700 includes updating 720 the UI definition file based at least in part on the additional configuration data. In some examples, the method 700 includes re-publishing 722 the GUI 110 using the updated UI definition file. In various examples, all or a portion of the method 700 is implemented using the micro-frontend ID module 204, configuration module 206, generation module 208, publishing module 210, rules module 302, conflict module 304, priority module 306, backend module 308, structure module 310, and/or update module 312, shown in FIGS. 2 and 3.

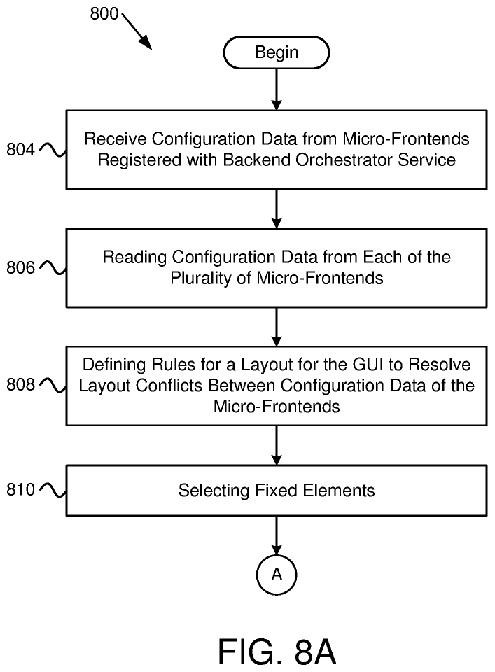

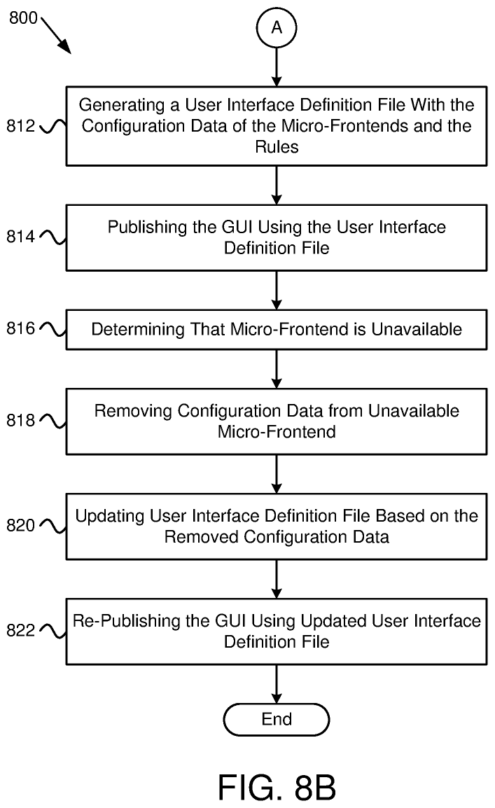

FIG. 8A is a schematic flow chart diagram illustrating steps of a method 800 for publishing and updating a GUI 410, according to various embodiments. In some examples, the method 800 begins and receives 804 configuration data from a plurality of micro-frontends registered with a backend orchestrator service 104. In some examples, each of the plurality of micro-frontends is configured to provide content to be displayed on a GUI 110. In some examples, each of the plurality of micro-frontends is from a content provider 106 that provides the content for the micro-frontend. The method 800 includes reading 806 the configuration data from each of the plurality of micro-frontends. In some examples, the configuration data of a micro-frontend of the plurality of micro-frontends includes identification of the micro-frontend and size and position information for display on the GUI 110 of the content of the micro-frontend.

In some examples, the method 800 includes defining 808, based at least in part on the configuration data, a number of rules for a layout for the GUI 110, the number of rules configured to resolve a layout conflict between the configuration data of the plurality of micro-frontends. In some examples, the UI definition file includes the number of rules. In some examples, the method 800 further includes identifying a conflict between configuration data of a first micro-frontend of the plurality of micro-frontends and configuration data of a second micro-frontend of the plurality of micro-frontends. In some examples, the method 800 includes determining a priority between the first micro-frontend and the second micro-frontend. In some examples, the method 800 includes selecting 810 a number of fixed elements not provided by the content provider.

FIG. 8B is a schematic flow chart diagram illustrating further steps of the method 800 of FIG. 8A, according to various embodiments. In some examples, the method 800 includes generating 812 a UI definition file. In some examples, the UI definition file includes the configuration data and the plurality of micro-frontends. In some examples, the method 810 includes publishing 814, using the UI definition file, the GUI 110. In some examples, publishing 814 the GUI 110 includes publishing each of the number of fixed elements to the GUI 110.

In some examples, the method 800 includes determining 816 that a micro-frontend is unavailable. In some examples, the method 800 includes removing 818 configuration data from the unavailable micro-frontend and updating 820 the UI definition file based on the removed configuration data. In some examples, the method 800 includes re-publishing 822 the GUI 110 using the updated UI definition file. In some examples, as shown in FIG. 4B, the updated GUI 410 does not include the de-selected micro-frontend 402c.

In various examples, all or a portion of the method 800 is implemented using the micro-frontend ID module 204, configuration module 206, generation module 208, publishing module 210, rules module 302, conflict module 304, priority module 306, backend module 308, structure module 310, and/or update module 312, shown in FIGS. 2 and 3.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving configuration data from each of a plurality of micro-frontends registered with a backend orchestrator service, each of the plurality of micro-frontends is configured to provide content to be displayed on a graphical user interface (“GUI”), wherein each of the plurality of micro-frontends is from a content provider that provides the content for the micro-frontend;
reading the configuration data from each of the plurality of micro-frontends, the configuration data of a micro-frontend of the plurality of micro-frontends comprising identification of the micro-frontend and size and position information for display on the GUI of the content of the micro-frontend;
generating a user interface definition file comprising the configuration data from the plurality of micro-frontends; and
publishing the GUI from the user interface definition file.

2. The method of claim 1, further comprising defining, based at least in part on the configuration data, a number of rules for a layout for the GUI, the number of rules configured to resolve a layout conflict between the configuration data of the plurality of micro-frontends, wherein the user interface definition file further comprises the number of rules.

3. The method of claim 2, wherein the layout conflict comprises an overlap between a first area of the GUI, the first area of the GUI defined by configuration data of a first micro-frontend of the plurality of micro-frontends, and a second area of the GUI, the second area of the GUI defined by configuration data of a second micro-frontend of the plurality of micro-frontends.

4. The method of claim 2, wherein defining, based at least in part on the configuration data, the number of rules further comprises:
identifying a conflict between configuration data of a first micro-frontend of the plurality of micro-frontends and configuration data of a second micro-frontend of the plurality of micro-frontends; and
determining a priority between the first micro-frontend and the second micro-frontend.

5. The method of claim 1, wherein reading the configuration data from each of the plurality of micro-frontends comprises reading the configuration data from a backend orchestration service, wherein each of the plurality of micro-frontends registers with the backend orchestration service and transmits configuration data of the micro-frontend to the backend orchestration service.

6. The method of claim 5, wherein generating the user interface definition file further comprises combining the configuration data of each of the plurality of micro-frontends into a unified structure in the user interface definition file.

7. The method of claim 5, wherein publishing the GUI further comprises accessing, via the backend orchestration service, the content from each of the plurality of micro-frontends.

8. The method of claim 1, further comprising selecting a number of fixed elements not provided by the content provider, wherein publishing the GUI comprises publishing each of the number of fixed elements to the GUI.

9. The method of claim 8, wherein the number of fixed elements comprises at least one of: a header of a page of the GUI, a footer of a page of the GUI, a navigation element of the GUI, a web address bar, a menu of the GUI, and/or any combination thereof.

10. The method of claim 1, wherein each of the plurality of micro-frontends comprises an address associated with the GUI.

11. The method of claim 1, wherein the size and position information comprise at least one of: a total area of the micro-frontend on the GUI, a page of the GUI on which to position the micro-frontend, and/or a region of a page of the GUI on which to position the micro-frontend.

12. The method of claim 1, further comprising:
determining that:
an additional micro-frontend has registered with the backend orchestration service;
content is available for a registered micro-frontend that was previously unavailable; and/or
a micro-frontend of the plurality of micro-frontends is unavailable;
reading configuration data from the additional micro-frontend or the micro-frontend that was previously unavailable and/or removing configuration data from the unavailable micro-frontend;
updating the user interface definition file based at least in part on the additional configuration data and/or the removed configuration data; and
re-publishing, using the updated user interface definition file, the GUI.

13. An apparatus comprising:
a micro-frontend ID module configured to receive configuration data from a plurality of micro-frontends registered with a backend orchestrator service, each of the plurality of micro-frontends is configured to provide content to be displayed on a graphical user interface (“GUI”), wherein each of the plurality of micro-frontends is from a content provider that provides the content for the micro-frontend;
a configuration module configured to read the configuration data from each of the plurality of micro-frontends, the configuration data of a micro-frontend of the plurality of micro-frontends comprising identification of the micro-frontend and size and position information for display on the GUI of the content of the micro-frontend;
a generation module configured to generate a user interface definition file, the user interface definition file comprising the configuration data from the plurality of micro-frontends; and
a publishing module configured to publish the GUI from the user interface definition file,
wherein at least a portion of said modules comprises hardware circuits, a programmable hardware device and/or code, the code stored on non-transitory computer readable storage media.

14. The apparatus of claim 13, further comprising a rules module configured to define, based at least in part on the configuration data, a number of rules for a layout for the GUI, the number of rules configured to resolve a layout conflict between the configuration data of the plurality of micro-frontends, wherein the user interface definition file further comprises the number of rules.

15. The apparatus of claim 14, wherein the layout conflict comprises an overlap between a first area of the GUI, the first area of the GUI defined by configuration data of a first micro-frontend of the plurality of micro-frontends, and a second area of the GUI, the second area of the GUI defined by configuration data of a second micro-frontend of the plurality of micro-frontends.

16. The apparatus of claim 14, wherein the apparatus further comprises:
a conflict module configured to identify a conflict between configuration data of a first micro-frontend of the plurality of micro-frontends and configuration data of a second micro-frontend of the plurality of micro-frontends; and
a priority module configured to determine a priority between the first micro-frontend and the second micro-frontend.

17. The apparatus of claim 13, further comprising a backend module configured to read the configuration data from a backend orchestration service, wherein each of the plurality of micro-frontends registers with the backend orchestration service and transmits configuration data of the micro-frontend to the backend orchestration service.

18. The apparatus of claim 17, further comprising a structure module configured to combine the configuration data of each of the plurality of micro-frontends into a unified structure, the unified structure configured to be used by the generation module to generate the user interface definition file.

19. The apparatus of claim 17, wherein the publishing module is further configured to publish the GUI by accessing, via the backend orchestration service, the content from each of the plurality of micro-frontends.

20. A program product comprising a non-transitory computer readable storage medium storing code, the code being configured to be executable by a processor to perform operations comprising:
receiving configuration data from each of a plurality of micro-frontends registered with a backend orchestration service, each of the plurality of micro-frontends is configured to provide content to be displayed on a graphical user interface (“GUI”), wherein each of the plurality of micro-frontends is from a content provider that provides the content for the micro-frontend;
reading the configuration data from each of the plurality of micro-frontends, the configuration data of a micro-frontend of the plurality of micro-frontends comprising identification of the micro-frontend and size and position information for display on the GUI of the content of the micro-frontend;
generating a user interface definition file comprising the configuration data the plurality of micro-frontends; and
publishing the GUI from the user interface definition file.
